(19) United States
(12) Patent Application Publication
(10) Pub. No.: US 2014/0068502 A1
(43) Pub. Date: Mar. 6, 2014

(54) DISPLAY DEVICE FOR DISPLAYING SCREEN INCLUDING SCROLLABLE LIST

(71) Applicant: Konica Minolta, Inc., Chiyoda-ku (JP)

(72) Inventors: Kazuhiro Tomiyasu, Toyokawa-shi (JP); Yoichi Kurumasa, Toyokawa-shi (JP); Tokuya Okada, Toyokawa-shi (JP); Kenichi Komaba, Toyokawa-shi (JP)

(73) Assignee: Konica Minolta, Inc., Chiyoda-ku (JP)

(21) Appl. No.: 14/012,228

(22) Filed: Aug. 28, 2013

(30) Foreign Application Priority Data
Aug. 29, 2012 (JP) 2012-189073

(51) Int. Cl. G06F 3/0485

(52) U.S. Cl. CPC G06F 3/0485
USPC 715/784

(57) ABSTRACT

An MFP as a display device includes a first display unit for displaying a screen including a list on an operation panel and a second display unit for displaying the screen on the operation panel in a format different from the first display unit. When flick operation is accepted to scroll the list in a predetermined direction, the MFP decides a scroll speed to scroll-display the list, based on which of the first and second display units displays the screen. If the size of characters in a case where the entire screen is displayed by the first display unit is smaller than the size of characters in a case where the entire screen is displayed by the second display unit, the MFP sets a scroll speed of the list displayed by the first display unit to be lower than a scroll speed of the list displayed by the second display.

This application is based on Japanese Patent Application No. 2012-189073 filed with the Japan Patent Office on Aug. 29, 2012, the entire content of which is hereby incorporated by reference.

### BACKGROUND OF THE INVENTION

1. Field of the Invention

The present invention relates to a display device for displaying a screen including a scrollable list, and more particularly to a display device with high visibility during scrolling.

2. Description of the Related Art

In recent years, portable information terminals such as tablets and smart phones have been sophisticated, and people carry portable information terminals instead of PCs (Personal Computers). Portable information terminals allow users to view or edit electronic documents freely at any place. Portable information terminals have been used in various business and daily situations.

With the sophistication of portable information terminals, a technique has been proposed which allows an image forming apparatus and a portable information terminal to cooperate with each other in an image forming system including the image forming apparatus and the portable information terminal. Specifically, a technique for remotely operating an image forming apparatus has been proposed, in which an image forming apparatus has a removable operation panel, or the same screen as the display screen on the operation panel is displayed on a portable information terminal, whereby the user interface such as the operation panel or the portable information terminal is used as a remote panel.

When a list is displayed on a remote panel, the image forming apparatus scroll-displays the list upon accepting from the user flick operation of sliding a finger on the touch panel of the remote panel.

Some image forming apparatuses can display a screen including a list in different display formats on the remote panel. For example, when the remote panel is in a landscape orientation (in which case, the long sides of the approximately rectangular display of the remote panel lie up and down), the remote panel provides landscape display (display in such a manner that the long side of a screen to be displayed corresponds to the long side of the display). When the remote panel is in a portrait orientation (in which case, the short sides of the approximately rectangular display of the remote panel lie up and down), the remote panel provides portrait display (display in such a manner that the long side of a screen to be displayed corresponds to the short side of the display). When the remote panel provides landscape display, the screen of a normal size appears on the remote panel. On the other hand, when the remote panel provides portrait display, the screen to be displayed is reduced in size and appears such that the long side of a screen to be displayed corresponds to the short side of the display of the remote panel. Therefore, the screen appearing on the remote panel is smaller in portrait display than in landscape display.

Documents 1 and 2 below disclose conventional display devices.

Document 1 below discloses a digital camera having a vertically long camera body generally shaped like a rectangular parallelepiped. An LCD panel is arranged on the back face of the digital camera in such an orientation that the longitudinal direction of the display screen agrees with the longitudinal direction of the camera body. In a shooting mode, a shot image is displayed in the upper portion of the display screen. During replay, the camera body is rotated 90° to achieve landscape orientation. In a replay mode, the display posture of the shot image is also rotated 90°, so that the shot image is displayed full-screen on the display screen.

Document 2 below discloses a technique in which when the user makes flick operation on a touch panel of an image display unit in a state in which a partial area of the entire image is displayed on the image display unit, a contact sensing unit senses the flick operation and calculates the amount of move. A system control unit increases a move distance of the partial area relative to a speed during touch up in the flick operation as the display range of the partial area displayed on the image display unit relative to the entire image decreases. According to the technique in Document 2 below, as the enlargement ratio of the image increases (as the display range relative to the entire image decreases), the moving velocity increases.

### Document 1: Japanese Laid-Open Patent Publication No. 2006-166248 (Patent No. 4411193)

### Document 2: Japanese Laid-Open Patent Publication No. 2011-034512

In the remote panels of conventional image forming apparatuses, when flick operation is accepted in a state in which items in a list form such as job history are displayed, the list is scroll-displayed. The remote panels of conventional image forming apparatuses have a problem that visibility during scrolling is low. More specifically, even in a case where the remote panel displays a screen including a list in different display formats, the scroll speed of the list is decided irrespective of the display formats. As a result, it is difficult to visually recognize information included in the list during scrolling of the list.

This is not only the problem with a remote panel of an image forming apparatus but the problem may generally happen with a display device that displays a screen including a list on a display in different formats.

### SUMMARY OF THE INVENTION

The present invention is made to solve the above-noted problem. An object of the present invention is to provide a display device with high visibility during scrolling.

According to an aspect of the present invention, a display device with a display includes: a first display unit for displaying a screen including a scrollable list containing a plurality of information represented by characters on the display; a second display unit for displaying the screen on the display in a format different from the first display unit; an operation accepting unit for accepting flick operation to scroll the list in a predetermined direction; and a speed decision unit for deciding a scroll speed to scroll-display the list, based on which of the first and second display units displays the screen when the operation accepting unit accepts flick operation. The speed decision unit decides a scroll speed for the accepted predetermined flick operation such that a scroll speed of the list displayed by the first display unit is slower than a scroll speed of the list displayed by the second display unit, in one of the following cases: (i) a size of a character in a case where the entire screen is displayed by the first display unit is smaller than a size of a character in a case where the entire screen is displayed by the second display unit; (ii) a length in a scroll direction of a display area for the list in a case where the entire screen is displayed by the second display unit is longer than a length in the scroll direction of a display area for the list in a case where the entire screen is displayed by the first display unit; (iii) a screen displayed by the first display unit includes a thumbnail related to the list, and a screen displayed by the second display unit does not include a thumbnail related to the list; and (iv) the list on the screen displayed by the second display unit is a list in which part of information in the list on the screen displayed by the first display unit is hidden.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an overall configuration of an image forming system in an embodiment of the present invention.

FIG. 2 is a block diagram showing an internal configuration of an MFP 1.

FIG. 3 is a diagram schematically showing a configuration of an operation panel 15.

FIG. 4 is a block diagram showing an internal configuration of a portable information terminal 100.

FIG. 5 is a diagram schematically showing a display screen in a case where the remote panel is in landscape orientation in a first example.

FIG. 6 is a diagram schematically showing a display screen in a case where the remote panel is in portrait orientation in the first example.

FIG. 7 is a diagram for explaining the relation between flick operation and scroll speed.

FIG. 8 is a flowchart showing operation of MFP 1 when login is accepted in the first example.

FIG. 9 is a flowchart showing operation of MFP 1 when a list screen is displayed in the first example.

FIG. 10 is a diagram schematically showing a display screen on the remote panel in a case where a list screen is displayed in a one-row display format in a second example.

FIG. 11 is a diagram schematically showing a display screen on the remote panel in a case where a list screen is displayed in a two-row display format in the second example.

FIG. 12 is a flowchart showing the second example of operation of MFP 1.

FIG. 13 is a diagram schematically showing a display screen on the remote panel in a case where a list screen is displayed in a normal display format in a third example.

FIG. 14 is a diagram schematically showing a display screen on the remote panel in a case where a list screen is displayed in an extended display format in the third example.

FIG. 15 is a flowchart showing the third example of operation of MFP 1.

FIG. 16 is a diagram schematically showing a display screen on the remote panel in a case where a list screen is displayed in a thumbnail display format in a fourth example.

FIG. 17 is a diagram schematically showing a display screen on the remote panel in a case where a list screen is displayed in a thumbnail-hidden format in the fourth example.

FIG. 18 is a flowchart showing the fourth example of operation of MFP 1.

FIG. 19 is a diagram schematically showing a user information table recorded in a fixed storage device 12.

FIG. 20 is a diagram schematically showing a display screen on the remote panel in a case where a list screen is displayed in a not-restricted display format in a fifth example.

FIG. 21 is a diagram schematically showing a display screen on the remote panel in a case where a list screen is displayed in a restricted display format in the fifth example.

FIG. 22 is a flowchart showing operation of MFP 1 when login is accepted in the fifth example.

FIG. 23 is a flowchart showing operation of MFP 1 when a list screen is displayed in the fifth example.

### DESCRIPTION OF THE PREFERRED EMBODIMENTS

In the following, an embodiment of the present invention will be described in conjunction with the figures.

In the following embodiment, a display device at least includes a display. Examples of the display device include an image forming apparatus with an operation panel removable from the image forming apparatus body, an image forming apparatus with an operation panel fixed (not removable) to the image forming apparatus body, and a portable information terminal (for example, a tablet or a smart phone) capable of wireless or wired communication with an image forming apparatus.

### [Configuration of Image Forming System]

First of all, an overall configuration of an image forming system in the present embodiment will be described.

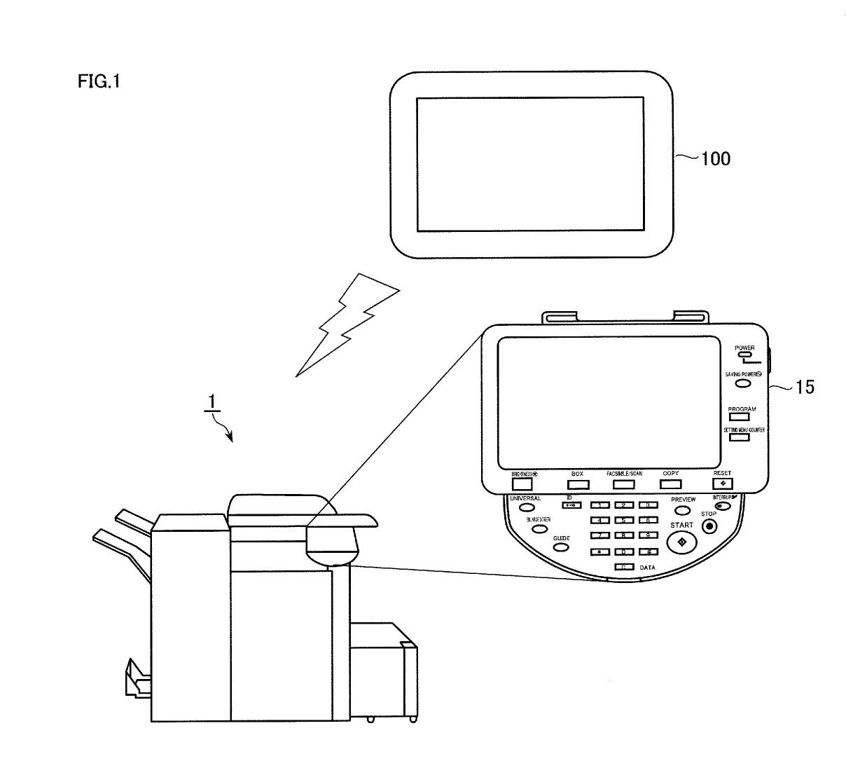

FIG. 1 is a diagram showing an overall configuration of an image forming system in an embodiment of the present invention. FIG. 1 shows an enlarged view of an operation panel 15 of an MFP 1.

Referring to FIG. 1, the image forming system in the present embodiment includes MFP 1 as an image forming apparatus and a portable information terminal 100. MFP 1 has a scanner function, a facsimile function, a copy function, a printer function, a data communication function, a server function, and the like. MFP 1 has operation panel 15 on the front surface thereof. Operation panel 15 displays various information concerning MFP 1 and accepts operation on MFP 1. Operation panel 15 is removably attached to the body (the part of MFP 1 excluding operation panel 15) of MFP 1. Portable information terminal 100 can wirelessly communicate with MFP 1.

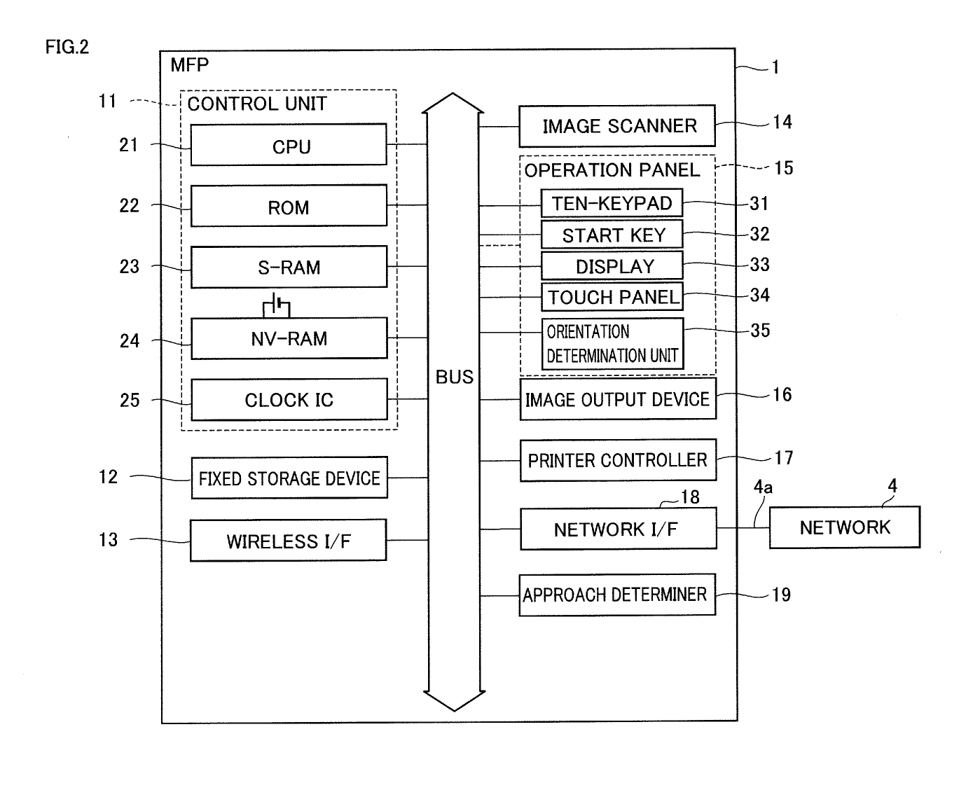

FIG. 2 is a block diagram showing an internal configuration of MFP 1.

Referring to FIG. 2, MFP 1 includes a control unit 11, a fixed storage device 12, a wireless I/F 13, an image scanner 14, an operation panel 15, an image output device 16, a printer controller 17, a network I/F 18, and an approach determiner 19. Fixed storage device 12, wireless I/F 13, image scanner 14, operation panel 15, image output device 16, printer controller 17, network I/F 18, and approach determiner 19 are each connected to control unit 11 through a bus.

Control unit 11 includes a CPU (Central Processing Unit) 21, a ROM (Read Only Memory) 22, an SRAM (Static Random Access Memory) 23, an NVRAM (Non Volatile Random Access Memory) 24, and a clock IC (Integrated Circuit) 25. CPU 21 executes a control program stored in ROM 22. ROM 22 stores a control program for controlling operation of MFP 1. SRAM 23 is a working memory for CPU 21. NVRAM 24 is battery-backed up to store various settings concerning image forming. Clock IC 25 counts the time.

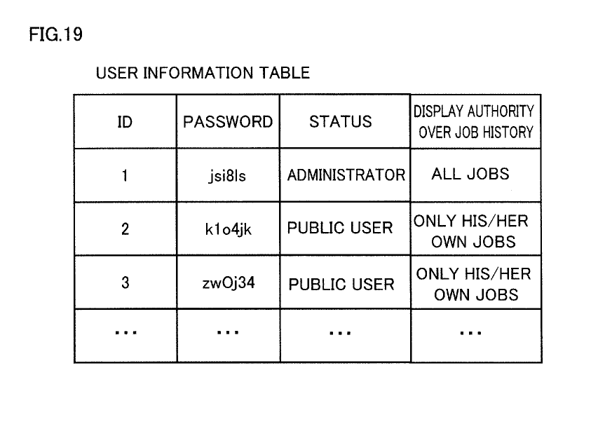

Fixed storage device 12 is, for example, an HDD (Hard Disk Drive) and stores a user information table (FIG. 19) and various information such as a list.

The list means a plurality of information represented by characters that is arranged in a certain form. Examples of the list include job history and an address book. The job history refers to records of history of jobs executed in MFP 1 and includes information such as the execution time, kind, and settings of a job. The address book refers to records of possible destinations of facsimile or mails or possible storage locations of scanned images and includes information such as the names of possible destinations or storage locations and facsimile numbers. The list may be a job list or a list of documents saved in a box of MFP 1.

Wireless I/F 13 is, for example, Bluetooth® or IrDA® for use in communication with external equipment.

Image scanner 14 scans a document image.

Operation panel 15 mainly includes a ten-keypad 31 for inputting numerals, a start key 32 for accepting an instruction to execute various jobs, a display 33 such as an LCD (Liquid Crystal Display) for displaying screens of various information, a touch panel 34 arranged on the front surface of display 33, and an orientation determination unit 35 for determining the orientation of the operation panel. Touch panel 34 accepts an operation input such as a tap or a flick to display 33. Orientation determination unit 35 determines the orientation (portrait orientation or landscape orientation) of operation panel 15 using an angular sensor provided at a hinge that supports the display, or an acceleration sensor that measures an acceleration applied to operation panel 15.

Image output device 16 forms a copy image on a sheet of paper.

Printer controller 17 generates a copy image from print data received by network I/F 18.

Network I/F 18 connects MFP 1 to a network 4 through a network cable 4a. Network I/F 18 transmits/receives various information to/from external equipment such as portable information terminal 100.

Approach determiner 19 senses an approach of a human body to MFP 1.

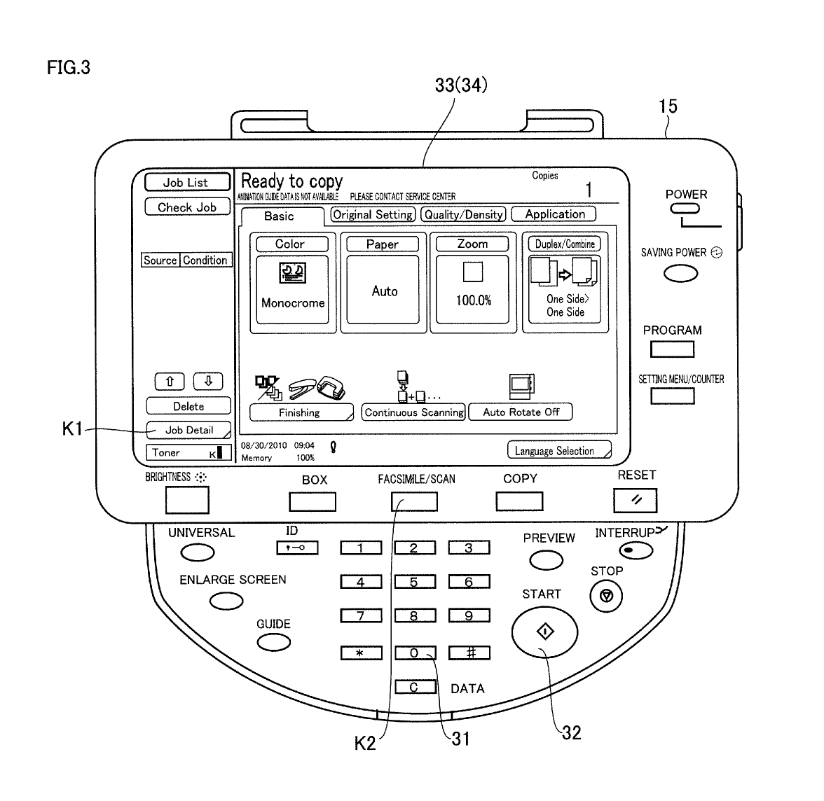

FIG. 3 is a diagram schematically showing a configuration of operation panel 15.

Referring to FIG. 3, operation panel 15 mainly includes ten-keypad 31 for accepting input of numerical values, start key 32 for accepting execution of a job of each function, display 33 for displaying setting items or messages, and touch panel 34 superimposed on display 33 for accepting settings from users.

In FIG. 3, operation panel 15 displays, for example, setting screens of various functions (here, a copy function) of MFP 1 on display 33. The setting screens of various functions include various keys for accepting settings for a particular function. A key K1 that is a “job details key” is displayed to the left of display 33. When key K1 is pressed, operation panel 15 displays job history stored in fixed storage device 12 on display 33. A key K2 that is a “fax/scan” key is provided below display 33. When key K2 is pressed, operation panel 15 displays an address book stored in fixed storage device 12 on display 33.

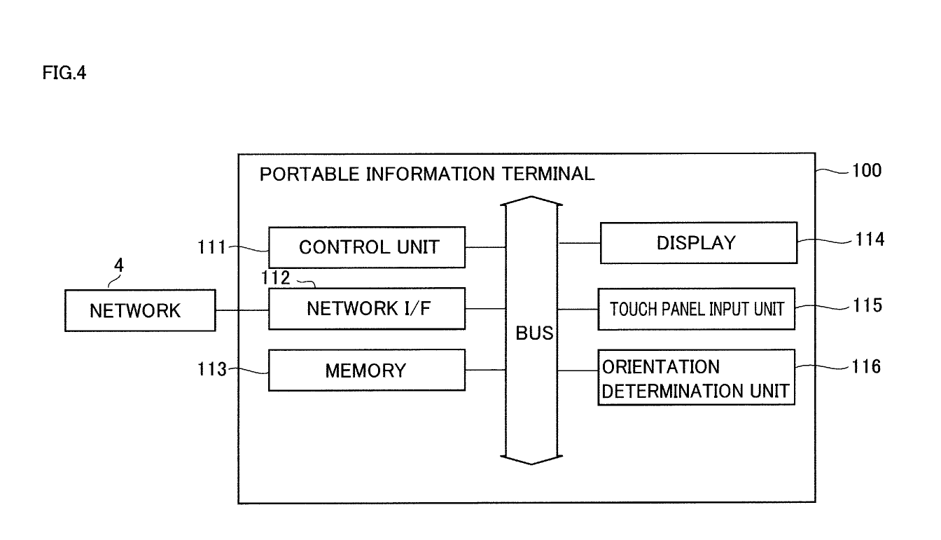

FIG. 4 is a block diagram showing an internal configuration of portable information terminal 100.

Referring to FIG. 4, portable information terminal 100 mainly includes a control unit 111, a network I/F 112, a memory 113, a display 114, a touch panel input unit 115, and an orientation determination unit 116. Network I/F 112, memory 113, display 114, touch panel input unit 115, and orientation determination unit 116 are each connected to control unit 111.

Control unit 111 centrally controls portable information terminal 100. Control unit 111 mainly includes a CPU for executing a control program for portable information terminal 100, a ROM for storing the control program, and a RAM as a working memory for the CPU.

Network I/F 112 connects portable information terminal 100 by wire or by radio to network 4. Network I/F 112 transmits/receives various information to/from MFP 1.

Memory 113 stores, for example, a program for an operating system for supporting the operation and use of portable information terminal 100 and a program of a remote panel application for operating MFP 1.

Display 114 is configured with, for example, an LCD and displays various information under the control of control unit 111.

Touch panel input unit 115 accepts operation on a screen appearing on portable information terminal 100.

Orientation determination unit 116 determines the orientation (portrait orientation or landscape orientation) of portable information terminal 100 relative to the gravity direction, based on an acceleration applied to portable information terminal 100.

When the remote panel application is launched in portable information terminal 100, MFP 1 accepts a notice that the remote panel application is launched from portable information terminal 100 and performs an authentication process for the user of portable information terminal 100. If the user authentication is successful, MFP 1 performs a login process for the user and permits the user to use a predetermined function of MFP 1. In this case, portable information terminal 100 displays the same screen (that is, the operation screen of MFP 1) as the display screen on display 33 of operation panel 15, on display 114, and displays a hardware key provided for operation panel 15 on display 114. When the remote panel application is launched, portable information terminal 100 notifies MFP 1 of the operation accepted from the user and displays a screen received from MFP 1 on display 114.

In the image forming system in the present embodiment, various information is displayed on operation panel 15 or portable information terminal 100, and operation is accepted from operation panel 15 or portable information terminal 100. The user interface such as operation panel 15 or portable information terminal 100 that can display various information of MFP 1 and remotely operate MFP 1 is hereinafter called a remote panel.

MFP 1 displays a screen (hereinafter also called a list screen) including a scrollable list containing a plurality of information represented by characters in different two formats on the remote panel. When input of flick operation (operation of sliding a finger on a screen) for scrolling the list by a certain distance is accepted from the remote panel, MFP 1 determines in which of the two formats the list screen is displayed, and decides a scroll speed of the list based on the determination result.

If the list is scrolled in a state in which the list screen is displayed in, of two different formats, a format in which the list scrolled is less visible, MFP 1 makes the scroll speed of the list slower than when the list screen is displayed in the other format, thereby improving the visibility during scrolling.

First to fifth examples of operation of the MFP will be described in order below. In the first to fifth examples, in a setting screen for making various settings of the MFP, display formats of a list screen are different.

### [First Example of Operation of MFP]

In the first example, MFP 1 switches display formats of a list screen between portrait display and landscape display, based on the orientation of the remote panel as determined by orientation determination unit 35 or 116, and the scroll speed is decided based on whether the display format of the list screen is portrait display or landscape display.

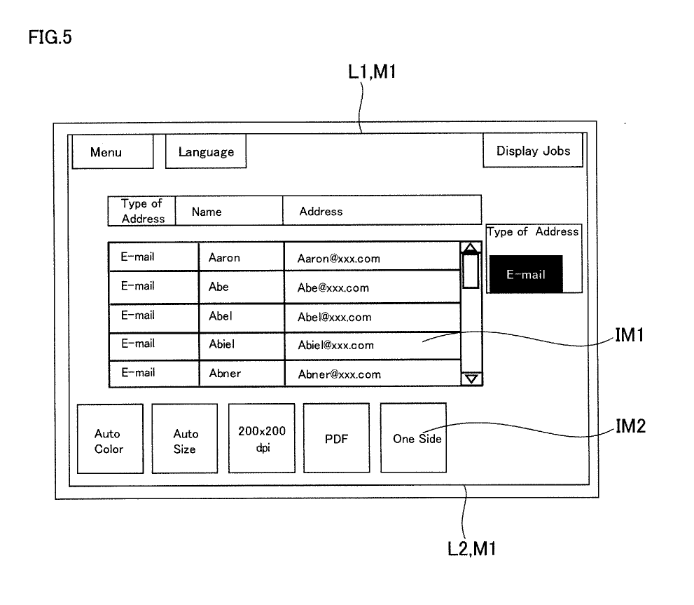

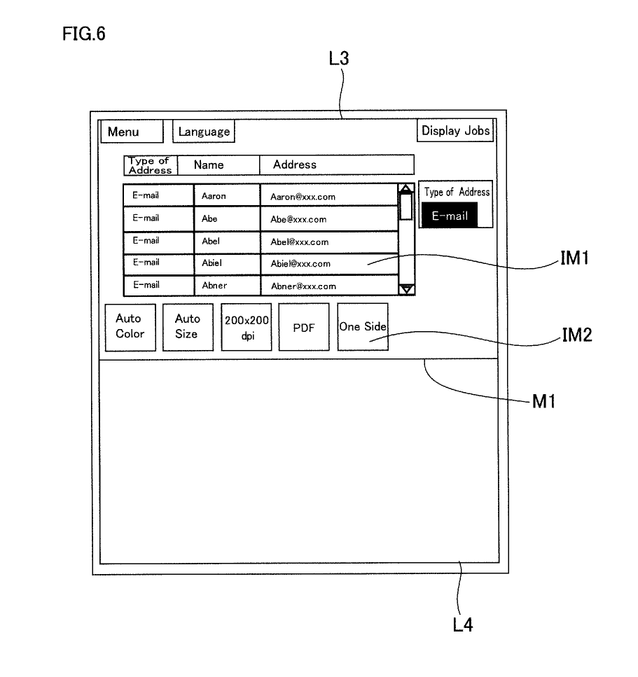

FIG. 5 is a diagram schematically showing a display screen in a case where the remote panel is in landscape orientation in the first example. FIG. 6 is a diagram schematically showing a display screen in a case where the remote panel is in portrait orientation in the first example.

Referring to FIG. 5 and FIG. 6, the remote panel has an approximately rectangular touch-panel display. On the remote panel, the entire list screen (the screen appearing when key K2 is pressed in FIG. 3) for settings of scan transmission is displayed. This list screen includes a list IM1 that is an address book and various information IM2 other than the list. Since list IM1 includes information including many destinations that ranges over multiple pages, the list cannot be displayed entirely in the display area for the list in the list screen. Therefore, a scroll bar is provided to the right of list IM1 to allow list IM1 to scroll in the vertical direction in the screen (in the vertical direction in FIG. 5 and FIG. 6). Various information IM2 cannot be scrolled.

In the horizontal direction of list IM1, the kind, the name, and the address of a destination registered in the address book are displayed. In the vertical direction of list IM1, the destinations registered in the address book are arranged.

MFP 1 displays the list screen in different two display formats on the remote panel. The first display format (the format in landscape display) is a display format in a case where the user holds the remote panel in landscape orientation, as shown in FIG. 5. More specifically, with the remote panel in landscape orientation, long sides L1 and L2 of the display of the remote panel lie up and down, one long side L1 of the display of the remote panel is located higher than the other long side L2. When the remote panel is held in landscape orientation, MFP 1 displays the list screen in the landscape display format, and the screen of a normal size appears on the remote panel. More specifically, MFP 1 displays the list screen such that long sides M1 of the list screen correspond to the long sides L1 and L2 of the display of the remote panel. In the landscape display format, the list screen is displayed to take up the entire display of the remote panel, and the characters in the list screen are displayed in a large size.

The second display manner (portrait display format) is a display format in which the user holds the remote panel in portrait orientation by rotating the remote panel in landscape orientation by 90°, as shown in FIG. 6. More specifically, with the remote panel in portrait orientation, short sides L3 and L4 of the display of the remote panel lie up and down, and one short side L3 of the display of the remote panel is located higher than the other short side L4. When the remote panel is held in portrait orientation, MFP 1 displays the list screen in the portrait display format so as to display the list screen upright in accordance with the orientation of the remote panel. More specifically, MFP 1 displays the list screen by reducing the size at the same ratio in the vertical direction and the horizontal direction so that long sides M1 of the list screen correspond to short sides L3 and L4 of the display of the remote panel.

In the portrait display format, the list screen is displayed to take up part (for example, the upper side) of the remote panel, while nothing appears in the rest (for example, the lower side) of the remote panel. The size of characters is smaller in the portrait display format than in the landscape display format.

When flick operation in the area (the flick target area) presenting list IM1 is accepted from the user in a state in which the list screen is displayed on the remote panel, MFP 1 allows list IM1 to scroll at a speed in accordance with the flick operation. In the first example, MFP 1 determines whether the list screen is displayed in the landscape display format or in the portrait display format. If the list screen is in the portrait display format, MFP 1 then makes the scroll speed slower than in the landscape display format.

The relation between flick operation and scroll speed will now be described.

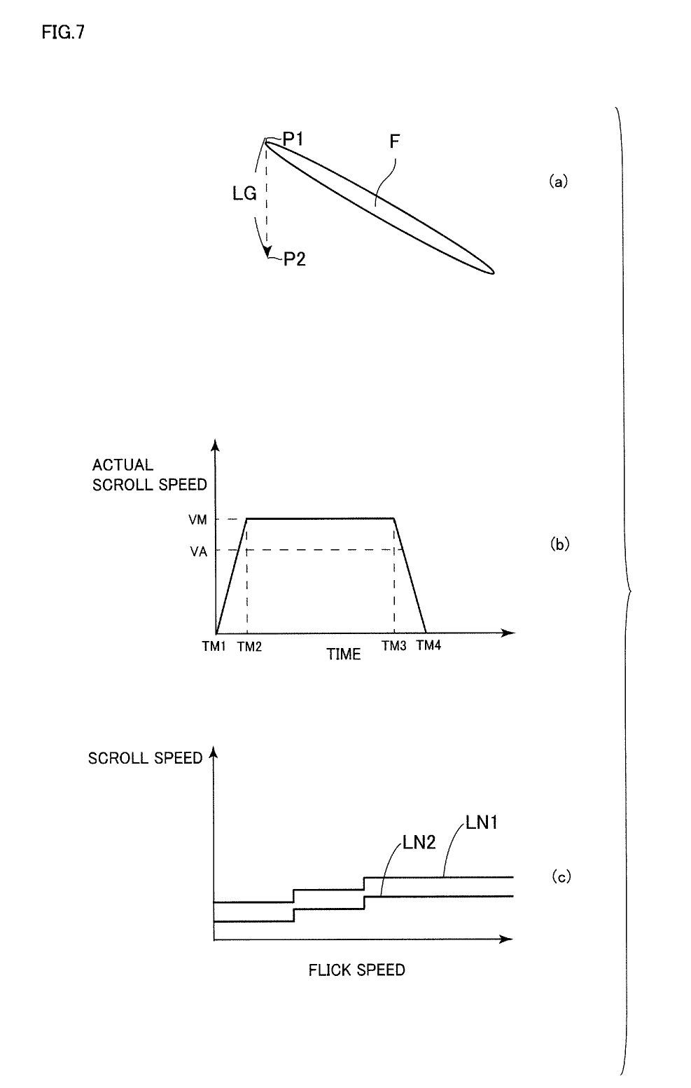

FIG. 7 is a diagram for explaining the relation between flick operation and scroll speed, wherein (a) shows the start point and the end point of flick operation, (b) shows the relation between actual scroll speed and time, and (c) shows the relation between flick speed and scroll speed.

Referring to FIG. 7(a), flick operation is performed by sliding (moving linearly) a finger or a stylus from a start point P1 to an end point P2. In general, the longer is the flick distance LG (the distance from start point P1 to end point P2), the longer is the distance scrolled.

Referring to FIG. 7(b), the actual scroll speed rapidly increases from time TM1 when flick operation is accepted to time TM2, keeps constant from TM2 to time TM3, rapidly decreases from time TM3 to time TM4, and becomes zero at time TM4.

In this specification, the scroll speed means the average speed VA or the maximum speed VM of scrolling from time TM1 to time TM4 (during scrolling).

Referring to FIG. 7(c), in general, the faster is the flick speed (the moving speed of a finger or a stylus), the faster is the scroll speed. The scroll speed in the landscape display format in the first example is represented by line LN1. The scroll speed in the portrait display format in the first example is represented by line LN2. When the scroll speed represented by line LN1 and the scroll speed represented by line LN2 are compared at the same flick speed, the scroll speed represented by line LN2 is lower than the scroll speed represented by line LN1 at every flick speed.

In the first to fifth examples, when the scroll speeds in two display formats are compared, it is a precondition that the flick operation (flick distance and flick speed) accepted from the user is the same in the two display formats.

The flowchart showing the first example of operation of MFP 1 will now be described.

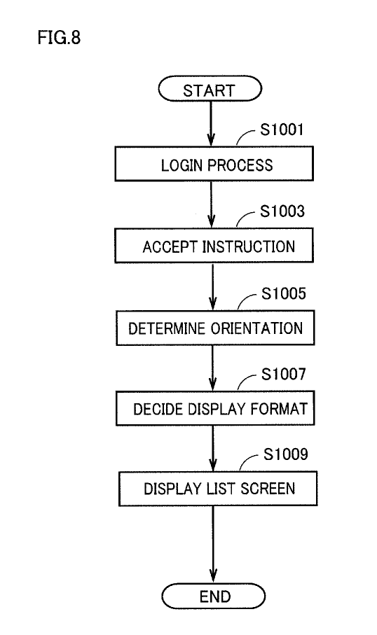

FIG. 8 is a flowchart showing operation of MFP 1 when login is accepted in the first example.

Referring to FIG. 8, when the user logs in, control unit 11 of MFP 1 performs a login process for the user (S1001). When an instruction to display a list screen is accepted from the remote panel (S1003), orientation determination unit 35 or 116 determines the orientation of the remote panel (S1005). Control unit 11 then decides a display format of the list screen based on the orientation of the remote panel (S1007) and displays the list screen in the decided display format (S1009). The process then ends.

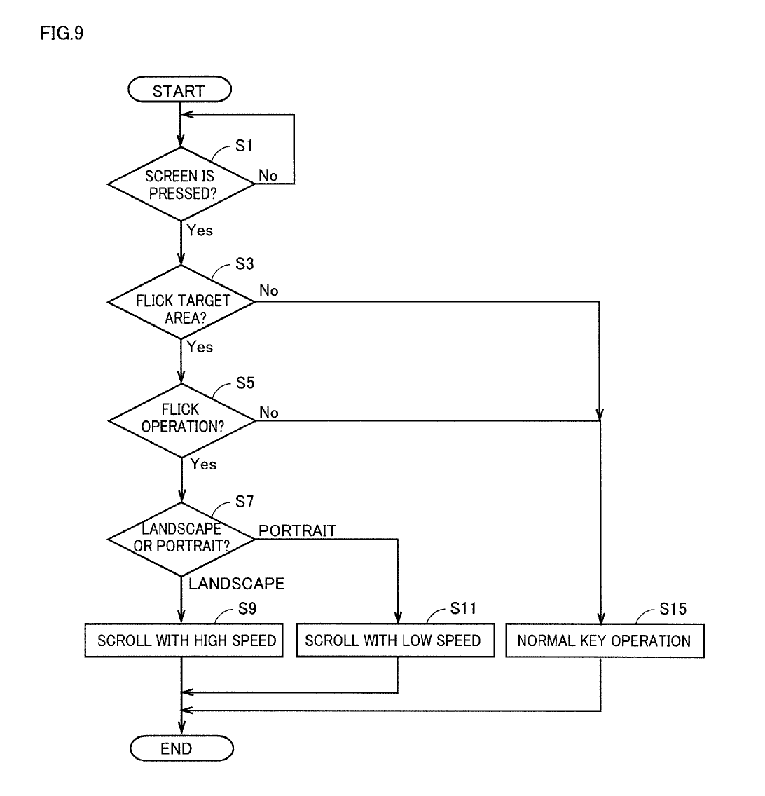

FIG. 9 is a flowchart showing operation of MFP 1 when a list screen is displayed in the first example.

Referring to FIG. 9, control unit 11 of MFP 1 determines whether the screen on the remote panel is pressed in a state in which the list screen is displayed (S1). If it is determined that it is pressed (YES in S1), it is determined whether the pressed position is in the flick target area (S3).

In step S3, if it is determined that it is in the flick target area (YES in S3), control unit 11 determines whether the accepted press is flick operation in a predetermined direction (S5).

In step S5, if it is determined that it is flick operation in a predetermined direction (YES in S5), control unit 11 determines whether the display format of the remote panel is the landscape display or the portrait display based on the determination result by orientation determination unit 35 or 116 (S7).

In S7, if it is determined that it is the landscape display (“landscape” in S7), control unit 11 sets the scroll speed high and allows the list screen to scroll in the accepted direction (S9). The process then ends. On the other hand, in step S7, if it is determined that it is the portrait display (“portrait” in S7), control unit 11 sets the scroll speed low and allows the screen to scroll (S11). The process then ends.

If it is determined that the pressed position is not in the flick target area in step S3 (NO in S3), or if it is determined that the accepted press is not flick operation in a predetermined direction in step S5 (NO in S5), control unit 11 determines that normal key operation has been done, and performs processing based on the key operation (S15). The process then ends.

When the entire list screen is displayed on the remote panel, the size of characters in list IM1 in the portrait display format is smaller than the size of characters in list IM1 in the landscape display format. Therefore, supposing that the scroll speed in the portrait display format is equal to the scroll speed in the landscape display format, it is difficult to visually recognize the list during scrolling in the portrait display format. Accordingly, the scroll speed in the portrait display format is set lower (restricted) than the scroll speed in the landscape display format as in the first example, thereby improving the visibility of the list during scrolling in the portrait display format.

MFP 1 may accept a choice between display formats from the user (for example, a choice made by pressing a software key on the remote panel) and may switch display formats of the list screen between portrait display and landscape display based on the choice, rather than based on the determination result by orientation determination unit 35 or 116.

The scroll speed may be set in accordance with the ratio in character size between the portrait display format and the landscape display format or may be set in accordance with the ratio of number of characters (the amount of information) scrolled per unit time. In the latter case, for example, if the number of characters per unit length in the scroll direction in the portrait display format is twice as many as the landscape display format because of a smaller character size or a smaller character size and spacing, the scroll speed in the scroll direction in the portrait display format is set to half of the scroll speed in the landscape display format.

### [Second Example of Operation of MFP]

In the second example, MFP 1 switches display formats of a list screen between a format in which one information in the list is displayed in a row (one-row display format) and a format in which it is displayed in two rows (two-row display format), based on the choice of a display format accepted from the user, and decides a scroll speed based on which format is the display state of the list screen.

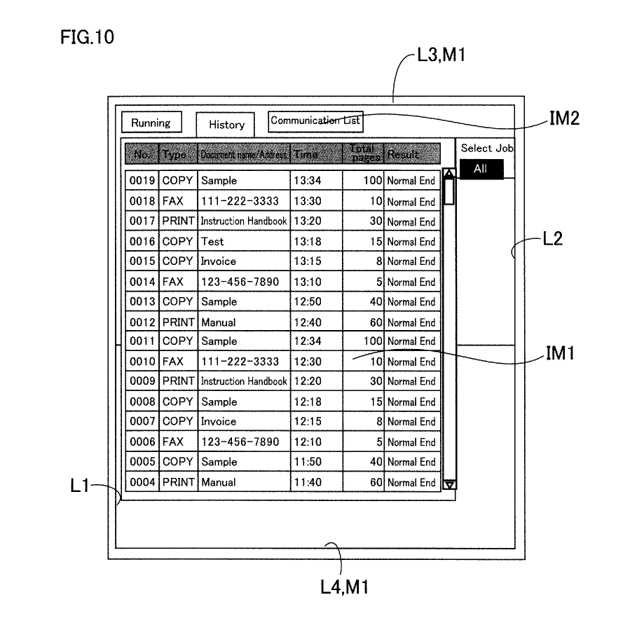

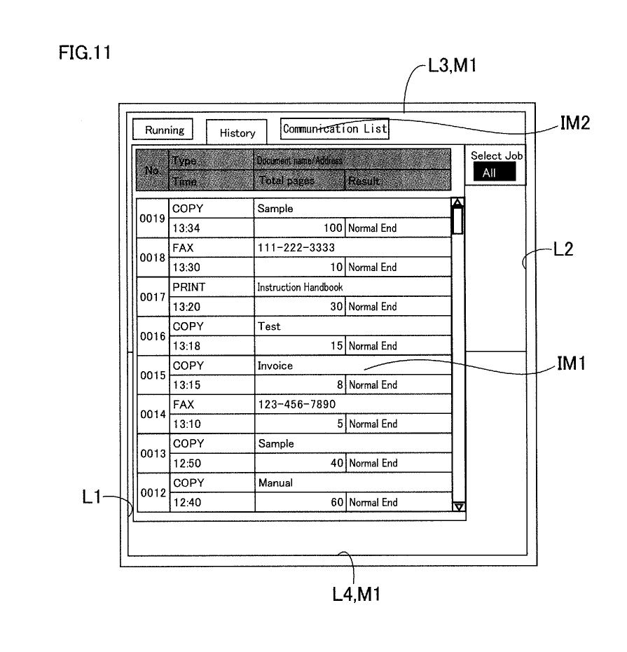

FIG. 10 is a diagram schematically showing a display screen on the remote panel in a case where a list screen is displayed in the one-row display format in the second example. FIG. 11 is a diagram schematically showing a display screen on the remote panel in a case where a list screen is displayed in the two-row display format in the second example.

Referring to FIG. 10 and FIG. 11, the remote panel has an approximately rectangular touch-panel display. The entire list screen of job history (the screen appearing when key K1 is pressed in FIG. 3) is displayed on the remote panel. This list screen includes a list IM1 that is job history and various information IM2 other than the list. Since list IM1 includes information of a number of jobs executed in MFP 1 that ranges over multiple pages, the list cannot be displayed entirely in the display area for the list in the list screen. Therefore, a scroll bar is provided to the right of list IM1 to allow list IM1 to scroll in the vertical direction in the screen (the vertical direction in FIG. 10 and FIG. 11). Various information IM2 cannot be scrolled. A software key for switching display formats may be further displayed in the list screen.

The display formats in FIG. 10 and FIG. 11 are both the portrait display format, in which MFP 1 displays the list screen such that long sides Ml of the list screen correspond to short sides L3 and L4 of the display of the remote panel. In this case, the list screen is reduced in the horizontal direction in a similar manner as in the portrait display format shown in FIG. 6. On the other hand, MFP 1 enlarges the display area for list IM1 in the vertical direction so as to fit with long sides L1 and L2 of the display of the remote panel. The display formats shown in FIG. 10 and FIG. 11 differ from the display format in FIG. 6 in that the display area for list IM1 is enlarged in the vertical direction.

In the one-row display format, as shown in FIG. 10, items for one job executed in MFP 1 (specifically, the number, the job type, the document name or destination, the time when the job was registered, the total number of copies of the job, and the execution result of the job) are displayed in a row in the horizontal direction of list IM1. Jobs are arranged in the vertical direction of list IM1. In the one-row display format, the size of characters in the horizontal direction is reduced.

In the two-row display format, as shown in FIG. 11, items for one job executed in MFP 1 are displayed in two rows in the horizontal direction of list IM1. Specifically, MFP 1 displays the number allocated to one job executed in MFP 1 in the first and second rows, displays the type of the job and the document name or destination in the first row, and displays the time when the job was registered, the total number of copies of the job, and the execution result of the job in the second row. Jobs are arranged in the vertical direction of list IM1.

In the two-row display format, the space given for the information concerning one job is increased, so that the size of characters is enlarged as compared with the one-row display format, and the size of characters displayed is almost the same as that of the landscape display format (the format shown in FIG. 5). The amount of information per row of the list in the two-row display format is smaller than in the one-row display format.

When flick operation in the area (the flick target area) presenting list IM1 is accepted from the user in a state in which the list screen is displayed on the remote panel, MFP 1 allows list IM1 to scroll at a speed in accordance with the flick operation. In the second example, MFP 1 determines whether the list screen is displayed in the one-row display format or in the two-row display format. If the list screen is displayed in the one-row display format, MFP 1 then makes the scroll speed slower than the scroll speed in the two-row display format.

The flowchart showing the second example of operation of MFP 1 will now be described.

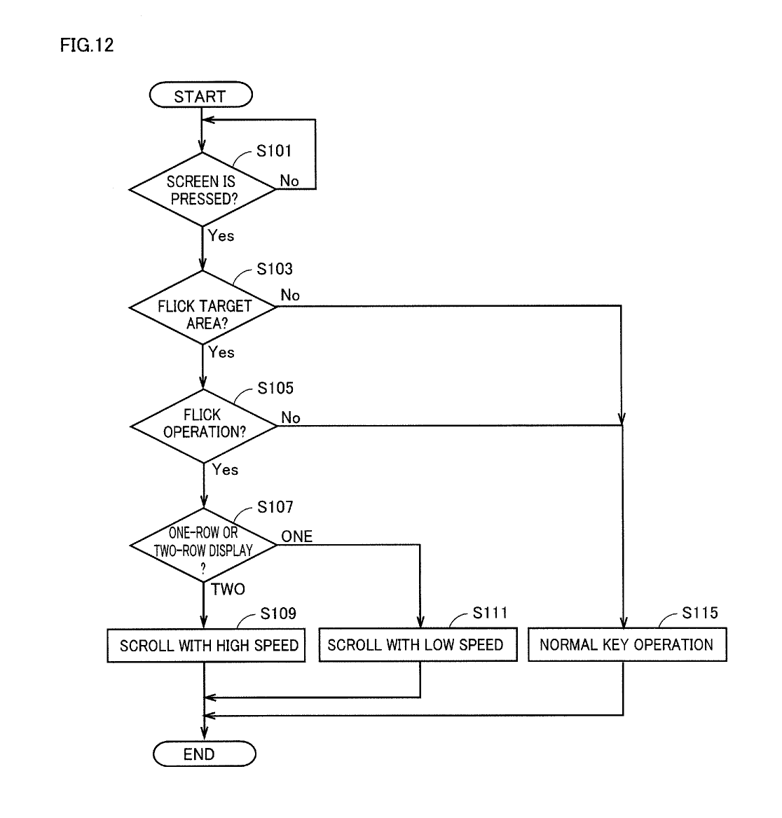

FIG. 12 is a flowchart showing the second example of operation of MFP 1.

Referring to FIG. 12, control unit 11 of MFP 1 determines whether the screen on the remote panel is pressed in a state in which the list screen is displayed (S101). If it is determined that it is pressed (YES in S101), it is determined whether the pressed position is in the flick target area (S103).

In step S103, if it is determined that it is in the flick target area (YES in S103), control unit 11 determines whether the accepted press is flick operation in a predetermined direction (S105).

In step S105, if it is determined that it is flick operation in a predetermined direction (YES in S105), control unit 11 determines whether the display format of the remote panel is the one-row display or the two-row display (S107).

In step S107, if it is determined that it is the two-row display (“two-row” in S107), control unit 11 sets the scroll speed high and allows the list screen to scroll in the accepted direction (S109). The process then ends. On the other hand, in step S107, if it is determined that it is the one-row display (“one-row” in S107), control unit 11 sets the scroll speed low and allows the screen to scroll (S111). The process then ends.

If it is determined that the pressed position is not in the flick target area in step S103 (NO in S103), or if it is determined that the accepted press is not flick operation in a predetermined direction in step S105 (NO in S105), control unit 11 determines that normal key operation has been done, and performs processing based on the key operation (S115). The process then ends.

When the entire list screen is displayed on the remote panel, the size of characters in list IM1 in the one-row display format is smaller than the size of characters in list IM1 in the two-row display format, and the amount of information per row in the one-row display format is larger than the amount of information per row in the two-row display format. Therefore, supposing that the scroll speed in the one-row display format is equal to the scroll speed in the two-row display format, it is difficult to visually recognize the list during scrolling in the one-row display format. Therefore, the scroll speed in the one-row display format is set lower than the scroll speed in the two-row display format as in the second example, thereby improving the visibility of the list during scrolling in the one-row display format.

In the second example described above, the first display format is a format in which one information in the list is displayed in one row, and the second display format is a format in which one information in the list is displayed in two rows. However, the list screen may be displayed such that each of a plurality of information is displayed in a first number of rows in the first display format, and that each of a plurality of information is displayed in a second number of rows that is greater than the first number in the second display format.

### [Third Example of Operation of MFP]

In the third example, MFP 1 switches display formats of a list screen between a format in which the display area for a list has a normal size (normal display format) and a format in which it has an extended size (extended display format), based on a choice between display formats accepted from the user, and decides a scroll speed based on which format is the display state of the list screen.

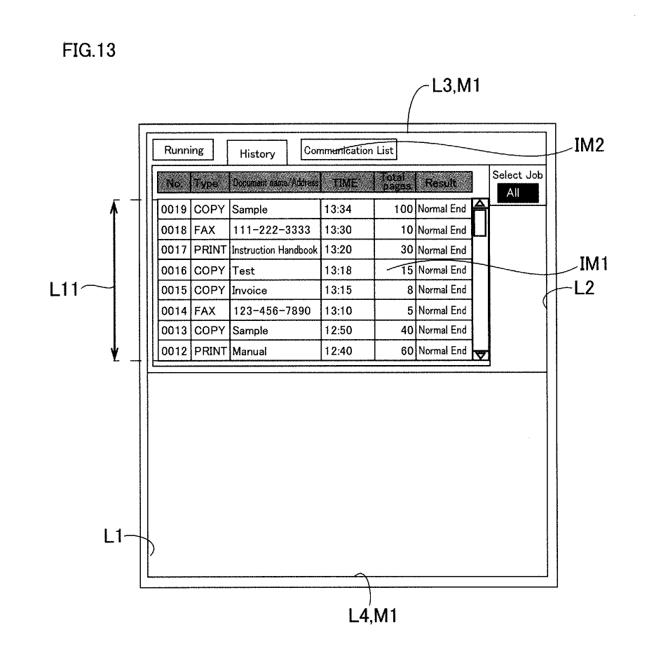

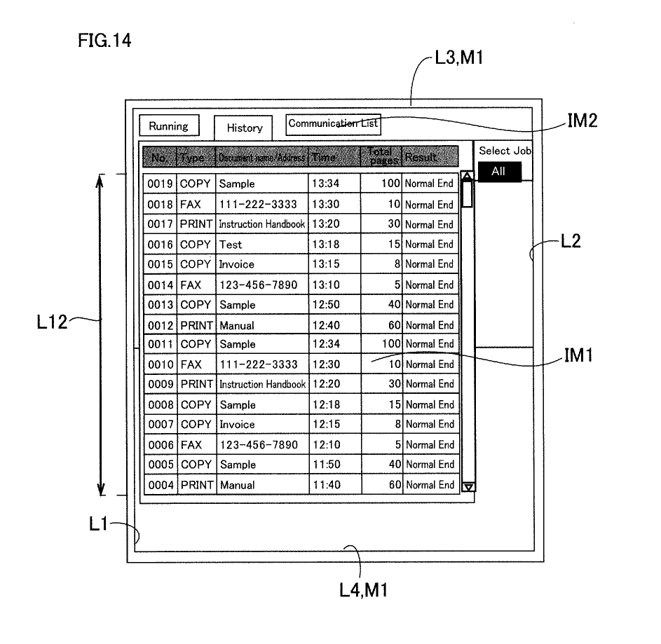

FIG. 13 is a diagram schematically showing a display screen on the remote panel in a case where a list screen is displayed in the normal display format in the third example. FIG. 14 is a diagram schematically showing a display screen on the remote panel in a case where a list screen is displayed in the extended display format in the third example.

Referring to FIG. 13 and FIG. 14, the remote panel has an approximately rectangular touch-panel display. The entire list screen of job history (the screen appearing when key K1 is pressed in FIG. 3) is displayed on the remote panel. This list screen includes a list IM1 that is job history and various information IM2 other than the list. Since list IM1 includes information of a number of jobs executed in MFP 1 that ranges over multiple pages, the list cannot be displayed entirely in the display area for the list in the list screen. Therefore, a scroll bar is provided to the right of list IM1 to allow list IM1 to scroll in the vertical direction in the screen (the vertical direction in FIG. 13 and FIG. 14). Various information IM2 cannot be scrolled. A software key for switching display formats may be further displayed on the list screen.

The display formats in FIG. 13 and FIG. 14 are both the portrait display format, in which MFP 1 displays the list screen such that long sides M1 of the list screen correspond to short sides L3 and L4 of the display of the remote panel. In this case, the list screen is reduced in the horizontal direction in a similar manner as in the portrait display format shown in FIG. 6.

In the normal display format, as shown in FIG. 13, the list screen displayed is reduced also in the vertical direction at the same reduction ratio as the reduction ratio in the horizontal direction. In the normal display format, the list screen is displayed so as to take up part (for example, the upper portion) of the remote panel, while nothing appears in the rest (for example, the lower portion) of the remote panel. When the entire list screen is displayed in the normal display format, the display area for the list has a length L11 along the direction (scroll direction) along long sides L1 and L2 of the display of the remote panel.

In the extended display format, as shown in FIG. 14, the display area for list IM1 is extended in the vertical direction (here, downward) so as to fit with long sides L1 and L2 of the display of the remote panel. In the extended display format, the list screen is displayed on the entire remote panel, and the lower space of the display is utilized. When the entire list screen is displayed in the extended display format, the display area for the list has a length L12 along the direction (scroll direction) along long sides L1 and L2 of the display of the remote panel. Length L12 is longer than length L11. The size of characters in the list is the same in the normal display format and the extended display format.

When flick operation in the area (the flick target area) presenting list IM1 is accepted from the user in a state in which the list screen is displayed on the remote panel, MFP 1 allows list IM1 to scroll at a speed in accordance with the flick operation. In the third example, MFP 1 determines whether the list screen is displayed in the normal display format or in the extended display format. If the list screen is displayed in the normal display format, MFP 1 then makes the scroll speed slower than the scroll speed in the extended display format.

The flowchart showing the third example of operation of MFP 1 will now be described.

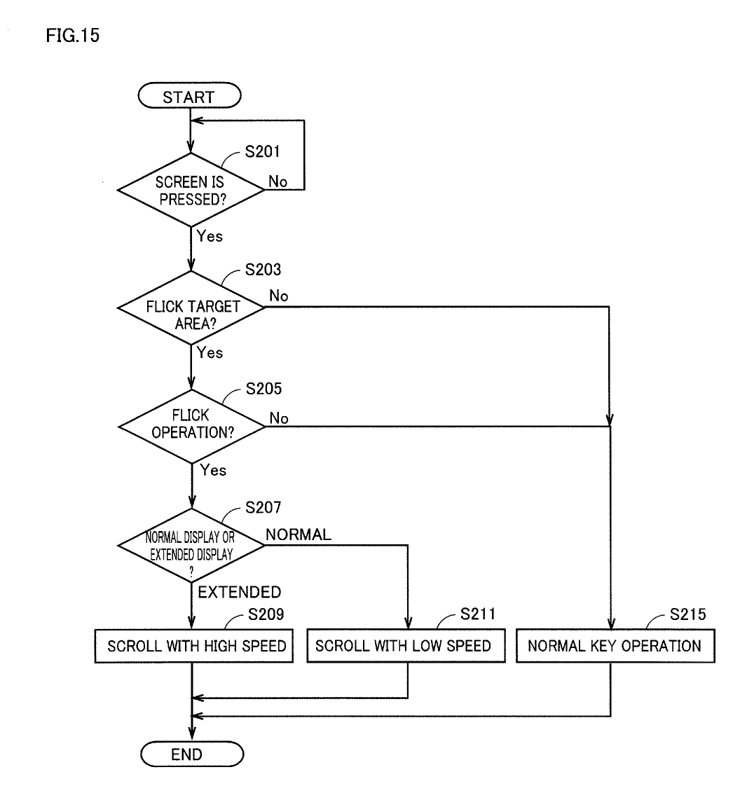

FIG. 15 is a flowchart showing the third example of operation of MFP 1.

Referring to FIG. 15, control unit 11 of MFP 1 determines whether the screen on the remote panel is pressed in a state in which the list screen is displayed (S201). If it is determined that it is pressed (YES in S201), it is determined whether the pressed position is in the flick target area (S203).

In step 5203, if it is determined that it is in the flick target area (YES in S203), control unit 11 determines whether the accepted press is flick operation in a predetermined direction (S205).

In step 5205, if it is determined that it is flick operation in a predetermined direction (YES in S205), control unit 11 determines whether the display format of the remote panel is the normal display or the extended display (S207).

In step 5207, if it is determined that it is the extended display (“extended” in S207), control unit 11 sets the scroll speed high and allows the list screen to scroll in the accepted direction (S209). The process then ends. On the other hand, in step S207, if it is determined that it is the normal display (“normal” in S207), control unit 11 sets the scroll speed low and allows the screen to scroll (S211). The process then ends.

If it is determined that the pressed position is not in the flick target area in step 5203 (NO in S203), or if it is determined that the accepted press is not flick operation in a predetermined direction in step 5205 (NO in S205), control unit 11 determines that normal key operation has been done, and performs processing based on the key operation (S215). The process then ends.

In the extended display format, the amount of information (the number of items) of the list displayed once is increased as compared with the normal display format. On the other hand, in the extended format, the length in the scroll direction (the length followed by the eyes) is secured, and, therefore, the visibility is not impaired in scroll display even when the scroll speed through flick operation is increased. Therefore, the scroll speed in the normal display is set lower than the scroll speed in the extended display as in the third example, thereby improving the visibility of the list during scrolling in the normal display format.

The scroll speed may be set such that the scroll time from one end to the other end of the scroll area is equal between the normal display format and the extended display format. For example, if the length in the scroll direction in the normal display format is half that of the extended display format, the scroll speed in the normal display format is reduced to half that of the extended display format.

### [Fourth Example of Operation of MFP]

In the fourth example, MFP 1 switches display formats of a list screen between a format in which a thumbnail concerning particular information in the list is displayed together with the list (thumbnail display format) and a format in which a thumbnail is not displayed (thumbnail-hidden format), based on operation by the user (for example, the choice of a display format accepted from the user), and decides a scroll speed based on which format is the display state of the list screen.

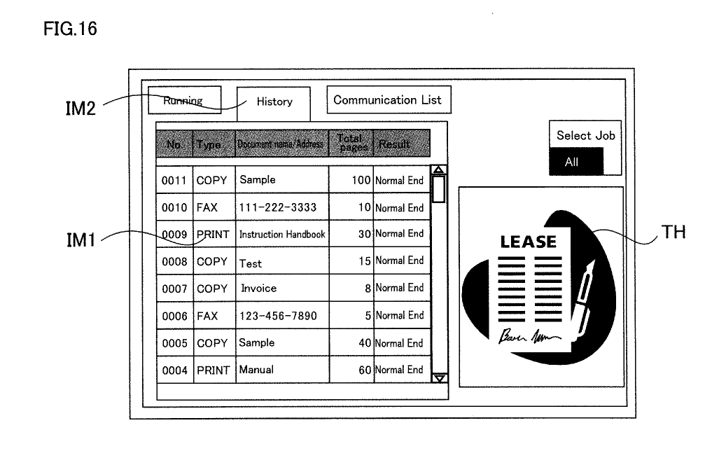

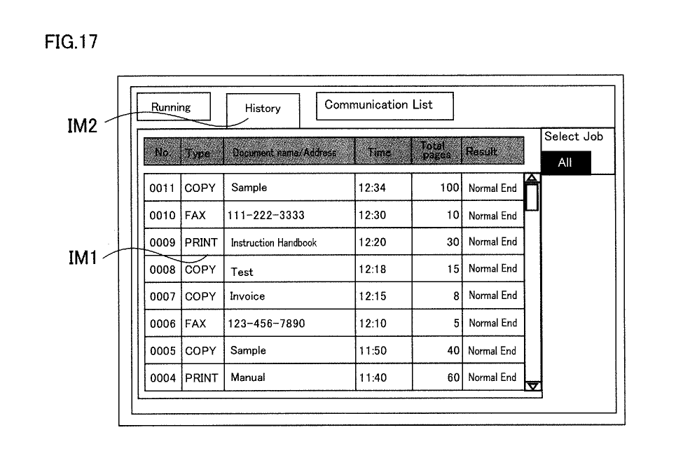

FIG. 16 is a diagram schematically showing a display screen on the remote panel in a case where a list screen is displayed in the thumbnail display format in the fourth example. FIG. 17 is a diagram schematically showing a display screen on the remote panel in a case where a list screen is displayed in the thumbnail-hidden format in the fourth example.

Referring to FIG. 16 and FIG. 17, the remote panel has an approximately rectangular touch-panel display. The entire list screen of job history (the screen appearing when key K1 is pressed in FIG. 3) is displayed on the remote panel. This list screen includes a list IM1 that is job history and various information IM2 other than the list. Since list IM1 includes information of a number of jobs executed in MFP 1 that ranges over multiple pages, the list cannot be entirely displayed in the display area for the list in the list screen. Therefore, a scroll bar is provided to the right of list IM1 to allow list IM1 to scroll in the vertical direction in the screen (the vertical direction in FIG. 16 and FIG. 17). Various information IM2 cannot be scrolled. A software key for switching display formats may be further displayed on the list screen.

In the thumbnail display format, as shown in FIG. 16, list IM1 is displayed on the left side of the list screen. The items including the number allocated to one job executed in MFP 1, the type of the job, the document name or destination, the total number of copies of the job, and the execution result of the job are displayed in the horizontal direction of list IM1. Jobs are arranged in the vertical direction of list IMI . A thumbnail TH related to list IM1 is displayed to the right of list IM1. Thumbnail TH is, for example, a thumbnail of a document used in the job displayed on the top of list IM1 (here, a document having a document name “sample” of the job having a job number “0011”). Display of thumbnail TH is changed when the job displayed on the top of list IM1 is changed by scrolling list IM1. By displaying thumbnail TH, information of a desired job can be easily found from the job history.

In the thumbnail-hidden format, as shown in FIG. 17, list IM1 is displayed at the center of the list screen. Items including the number allocated to one job executed in MFP 1, the type of the job, the document name or destination, the registration time, the total number of copies of the job, and the execution result of the job are displayed in the horizontal direction of list IM1. Jobs are arranged in the vertical direction of list IM1.

The thumbnail display format differs from the thumbnail-hidden format in that thumbnail TH is displayed. In the thumbnail-hidden format, a space for displaying a thumbnail is unnecessary. In the thumbnail-hidden format, therefore, the number of items in list IM1 can be larger than the number of items in list IM1 in the thumbnail display format. The size of characters in the list is the same in the thumbnail display format and the thumbnail-hidden format.

When flick operation in the area (the flick target area) presenting list IM1 is accepted from the user in a state in which the list screen is displayed on the remote panel, MFP 1 allows list IM1 to scroll at a speed in accordance with the flick operation. In the fourth example, MFP 1 determines whether the list screen is displayed in the thumbnail display format or in the thumbnail-hidden format. If the list screen is displayed in the thumbnail display format, MFP 1 then makes the scroll speed slower than the scroll speed in the thumbnail-hidden format.

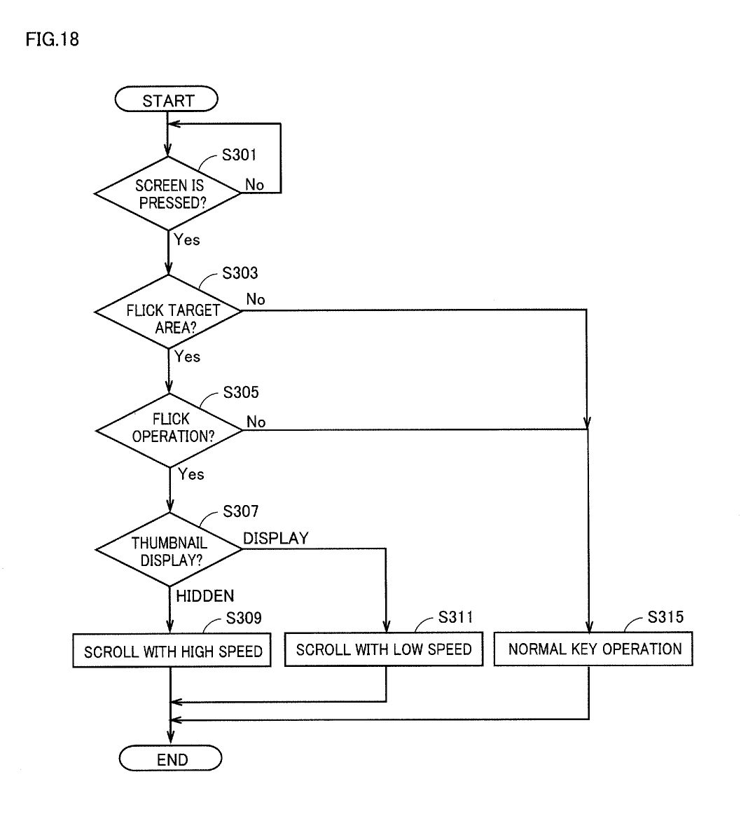

FIG. 18 is a flowchart showing the fourth example of operation of MFP 1.

Referring to FIG. 18, control unit 11 of MFP 1 determines whether the screen on the remote panel is pressed in a state in which the list screen is displayed (S301). If it is determined that it is pressed (YES in S301), it is determined whether the pressed position is in the flick target area (S303).

In step S303, if it is determined that it is in the flick target area (YES in S303), control unit 11 determines whether the accepted press is flick operation in a predetermined direction (S305).

In step S305, if it is determined that it is flick operation in a predetermined direction (YES in S305), control unit 11 determines whether the display format of the remote panel is the thumbnail display or the thumbnail-hidden (S307).

In step S307, if it is determined that it is the thumbnail-hidden (“hidden” in S307), control unit 11 sets the scroll speed high and allows the list screen to scroll in the accepted direction (S309). The process then ends. On the other hand, in step S307, if it is determined that it is the thumbnail display (“display” in S307), control unit 11 sets the scroll speed low and allows the screen to scroll (S311). The process then ends.

If it is determined that the pressed position is not in the flick target area in step S303 (NO in S303), or if it is determined that the accepted press is not flick operation in a predetermined direction in step S305 (NO in S305), control unit 11 determines that normal key operation has been done, and performs processing based on the key operation (S315). The process then ends.

When a thumbnail is displayed on the list screen, the user views both the information in the list and the thumbnail and thus takes more time to view the information on the list screen than when the thumbnail is hidden. Therefore, the scroll speed in the thumbnail display format is set lower than the scroll speed in the thumbnail hidden format as in the fourth example, thereby improving the visibility of the list during scrolling in the thumbnail display format.

### [Fifth Example of Operation of MFP]

In the fifth example, MFP 1 switches display formats of a list screen between a format in which all the information in the list is displayed (not-restricted display format) and a format in which part of the information in the list is hidden (restricted display format), based on the authority of the user who logs in (authenticated user), and decides a scroll speed based on which of the not-restricted display format and the restricted display format is the display format of the list screen.

FIG. 19 is a diagram schematically showing a user information table recorded in the fixed storage device 12.

Referring to FIG. 19, information of users allowed to use MFP 100 is recorded in the user information table. Various information of an individual user is arranged in the horizontal direction (row direction) of the user information table. Specifically, items including “ID”, “password”, “status”, and “display authority over job history” for an individual user are arranged.

The item “status” represents whether the user is an administrator of MFP 1 or a public user of MFP 1. In addition to these statuses, any other status (for example, “group leader”) may be provided.

The item “display authority over job history” represents information that can be displayed (information over which the user has authority), of the information included in the job history, when the user displays job history on the remote panel

In the user information table in FIG. 19, the administrator has display authority over all the jobs, and when the administrator displays job history on the remote panel, the job history is displayed in the not-restricted display format. The public user has display authority over only his/her own jobs, and when the public user displays job history on the remote panel, the job history is displayed in the restricted display format. Specifically, for example, a user having an ID “3” has a password “zwOj34” and is a public user. It is understood that job history is displayed for this user in such a manner that jobs of others are hidden.

For example, when the remote panel application is launched in portable information terminal 100, MFP 1 accepts a notice that the remote panel application is launched from portable information terminal 100 and performs a user authentication process based on the ID and password accepted from portable information terminal 100. If the user authentication is successful, MFP 1 performs a login process for the user and refers to the user information table to identify the status of the user. When the user logs in from operation panel 15, MFP 1 performs a user authentication process based on the ID and password accepted from operation panel 15. If the user authentication is successful, MFP 1 performs a login process for the user and refers to the user information table to identify the status of the user. When the job history is displayed on the remote panel, MFP 1 decides which of the not-restricted display format and the restricted display format is employed to display the list, based on the status of the user that is recorded in the user information table.

A product number or an IP address of the user interface used by each user may be recorded in place of an ID in the user information table. The display format of the list screen for that user in the first to the fourth examples may be recorded in the user information table. In this case, control unit 11 may display the list screen on the remote panel in the display format as recorded in the user information table.

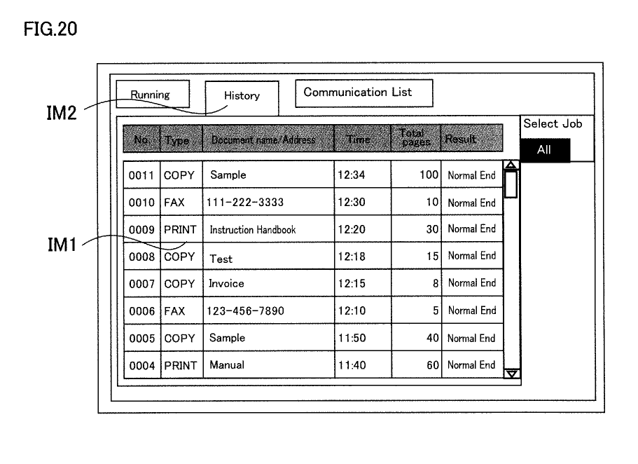

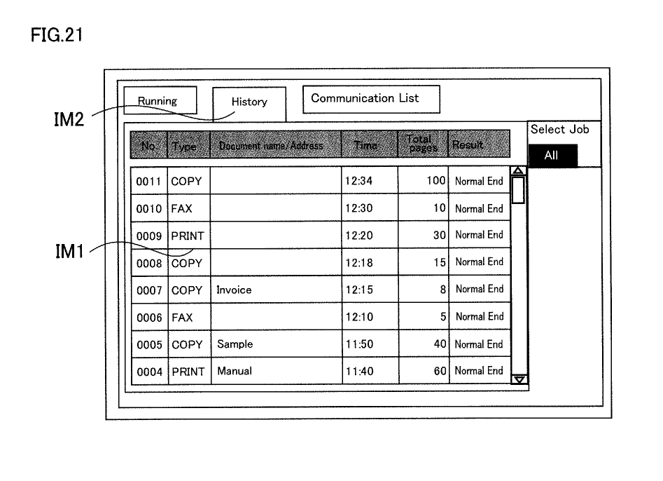

FIG. 20 is a diagram schematically showing a display screen on the remote panel in a case where a list screen is displayed in the not-restricted display format in the fifth example. FIG. 21 is a diagram schematically showing a display screen on the remote panel in a case where a list screen is displayed in the restricted display format in the fifth example.

Referring to FIG. 20 and FIG. 21, the remote panel has an approximately rectangular touch-panel display. The entire list screen of job history (the screen appearing when key K1 is pressed in FIG. 3) is displayed on the remote panel. This list screen includes a list IM1 that is job history and various information IM2 other than the list. Since list IM1 includes information of a number of jobs executed in MFP 1 that ranges over multiple pages, the list cannot be entirely displayed in the display area for the list in the list screen. Therefore, a scroll bar is provided to the right of list IM1 to allow list IM1 to scroll in the vertical direction in the screen (the vertical direction in FIG. 20 and FIG. 21). Various information IM2 cannot be scrolled.

In the not-restricted display format, as shown in FIG. 20, all the information of items including the number allocated to one job executed in MFP 1, the type of the job, the document name or destination, the registration time of the job, the total number of copies of the job, and the execution result of the job are displayed.

In the restricted display format, as shown in FIG. 21, of the items including the number allocated to one job executed in MFP 1, the type of the job, the document name or destination, the registration time of the job, the total number of copies of the job, and the execution result of the job, part of information, which is the item “document name or destination”, is hidden. The information hidden is information of jobs of users other than the user who displays the job history.

The size of characters in the list is the same in the not-restricted display format and the restricted display format. The arrangement position of the displayed list is also the same. The kind of information to be hidden in the list can be set as desired and can be decided depending on the kind of the list or the kind of information. The hidden information may be represented by a blank character or may be a dummy character or mark.

When flick operation in the area (the flick target area) representing list IM1 is accepted from the user in a state in which the list screen is displayed on the remote panel, MFP 1 allows list IM1 to scroll at a speed in accordance with the flick operation. In the fifth example, MFP 1 determines whether the list screen is displayed in the not-restricted display format or in the restricted display format. If the list screen is displayed in the not-restricted display format, MFP 1 then sets the scroll speed lower than the scroll speed in the restricted display format.

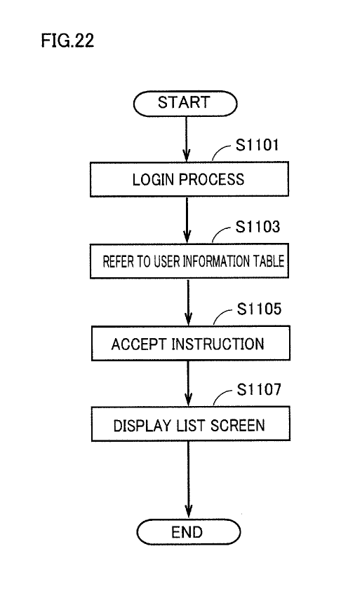

FIG. 22 is a flowchart showing operation of MFP 1 when login is accepted in the fifth example.

Referring to FIG. 22, when the user logs in, control unit 11 of MFP 1 performs a login operation for the user (S1101) and refers to the user information table to identify the status and display authority of that user (S1103). Control unit 11 then accepts an instruction to display job history from the remote panel (S1105) and displays the list screen in the display format based on the display authority of the user (S1107). The process then ends.

The flowchart showing the fifth example of operation of MFP 1 will now be described.

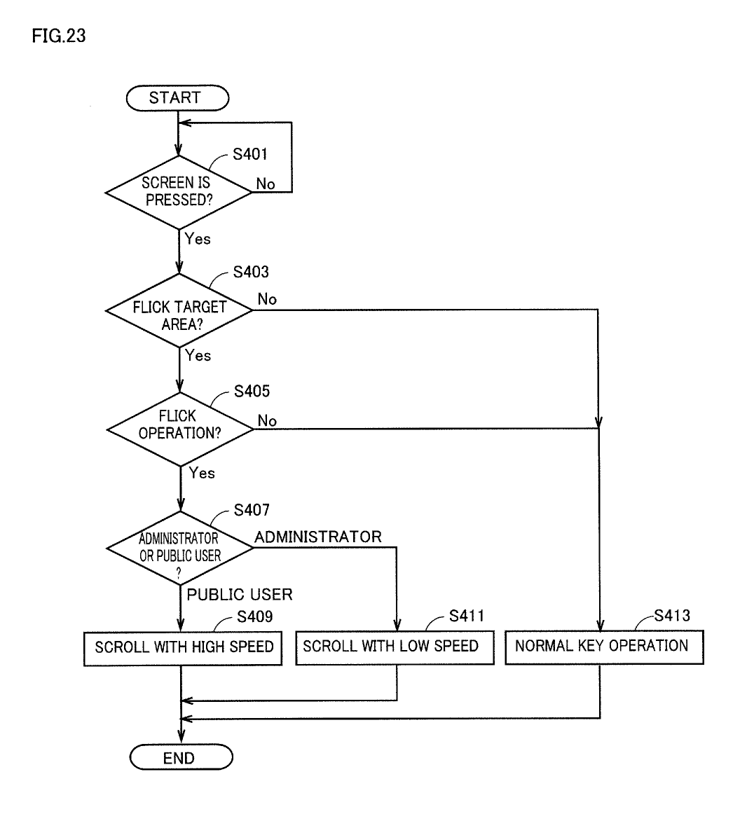

FIG. 23 is a flowchart showing operation of MFP 1 when a list screen is displayed in the fifth example.

Referring to FIG. 23, control unit 11 determines whether the screen on the remote panel is pressed in a state in which the list screen is displayed (S401). If it is determined that it is pressed (YES in S401), it is determined whether the pressed position is in the flick target area (S403).

In step 5403, if it is determined that it is in the flick target area (YES in S403), control unit 11 determines whether the accepted press is flick operation in a predetermined direction (S405).

In step S405, if it is determined that it is flick operation in a predetermined direction (YES in S405), control unit 11 determines whether the status of the user of the remote panel is an administrator or a public user (S407).

In step S407, if it is determined that the user is a public user (“public” in S407), control unit 11 sets the scroll speed high and allows the list screen to scroll in the accepted direction (S409). The process then ends. On the other hand, in step S409, if it is determined that the user is an administrator (“administrator ” in S409), control unit 11 sets the scroll speed low and allows the screen to scroll (S411). The process then ends.

If it is determined that the pressed position is not in the flick target area in step S403 (NO in S403), or if it is determined that the accepted press is not flick operation in a predetermined direction in step 5405 (NO in S405), control unit 11 determines that normal key operation has been done, and performs processing based on the key operation (S415). The process then ends.

For the purpose of security, the items of the job history may be displayed or hidden in accordance with the status of the user who logs in to MFP 1. In this case, if the user who logs in is an administrator, all the content of the job history are displayed, so that the user has more content to view and find it difficult to view the content if it is scrolled at high speed. On the other hand, if the user who logs in is a public user, some content of the job history is hidden, so that the user has less content to view and can view the content even when it is scrolled at high speed. Accordingly, the scroll speed is made slow in the not-restricted display manner, whereas the scroll speed is made fast in the display restricted manner, thereby improving the visibility of the list during scrolling.

MFP 1 may accept a choice between display formats from the user and switch the display formats of the list screen based on the choice, rather than based on the authority of the user who logs in (authenticated user).

### Effects of Embodiment

The foregoing embodiment can provide a display device with high visibility during scrolling.

According to the foregoing embodiment, when a list is scrolled in a state in which the list screen is displayed in, of two different formats, a format in which the list is less visible when scrolled, MFP 1 makes the scroll speed of the list slower thereby improving the visibility during scrolling and the operability of the remote panel.

### Others

The image forming apparatus is the one that performs operation according to at least one of the first to fifth examples above. The first to fifth examples above can be combined with each other.

In the foregoing embodiment, control unit 11 of MFP 1 controls display formats of the screen of portable information terminal 100. However, portable information terminal 100 may control display formats of the list screen of portable information terminal 100 under the control of the CPU of portable information terminal 100 per se. The display device may not necessarily make various settings of the image forming apparatus and may provide display independent of the image forming apparatus.

The process in the foregoing embodiment may be performed by software or using hardware circuitry. A program for executing the process in the foregoing embodiment may be provided. A recording medium, such as a CD-ROM, a flexible-disk, a hard disk, a ROM, a RAM, or a memory card, encoded with the program may be provided to users. The program is executed by a computer such as a CPU. The program may be downloaded to the device through a communication line such as the Internet.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A display device with a display, comprising:
a first display unit for displaying a screen including a scrollable list containing a plurality of information represented by characters on the display;
a second display unit for displaying the screen on the display in a format different from the first display unit;
an operation accepting unit for accepting flick operation to scroll the list in a predetermined direction; and
a speed decision unit for deciding a scroll speed to scroll-display the list, based on which of the first and second display units displays the screen when the operation accepting unit accepts flick operation, wherein
the speed decision unit decides a scroll speed for the accepted predetermined flick operation such that a scroll speed of the list displayed by the first display unit is slower than a scroll speed of the list displayed by the second display unit, in one of the following cases:
(i) a size of a character in a case where the entire screen is displayed by the first display unit is smaller than a size of a character in a case where the entire screen is displayed by the second display unit;
(ii) a length in a scroll direction of a display area for the list in a case where the entire screen is displayed by the second display unit is longer than a length in the scroll direction of a display area for the list in a case where the entire screen is displayed by the first display unit;
(iii) a screen displayed by the first display unit includes a thumbnail related to the list, and a screen displayed by the second display unit does not include a thumbnail related to the list; and
(iv) the list on the screen displayed by the second display unit is a list in which part of information in the list on the screen displayed by the first display unit is hidden.

2. The display device according to claim 1, further comprising:
an orientation determination unit for determining an orientation of the display; and
a first display decision unit for deciding which of the first and second display units displays the screen, based on the orientation determined by the orientation determination unit, wherein
the first display unit displays the screen such that a long side of the screen corresponds to a short side of the display that is approximately rectangular, and
the second display unit displays the screen such that a long side of the screen corresponds to a long side of the display that is approximately rectangular.

3. The display device according to claim 1, wherein
the first display unit displays the screen such that each of the plurality of information is displayed in a first number of rows, and
the second display unit displays the screen such that each of the plurality of information is displayed in a second number of rows that is greater than the first number of rows.

4. The display device according to claim 1, wherein
the first and second display units display the screen such that a long side of the screen corresponds to a short side of the display that is approximately rectangular,
the first display unit displays the screen such that when the entire screen is displayed, a length of a display area for the list in a direction along a long side of the display has a first length, and
the second display unit displays the screen such that when the entire screen is displayed, the length of the display area of the list in the direction along the long side of the display has a second length longer than the first length.

5. The display device according to claim 1, wherein
the first display unit displays a thumbnail of a file related to the list together with the list, and
the second display unit does not display the thumbnail.

6. The display device according to claim 1, further comprising:
an authority identifying unit for identifying authority of a user who uses the display device; and
a second display decision unit for deciding which of the first and second display units displays the screen, based on the authority identified by the authority identifying unit, wherein
the second display unit displays the screen in a format in which part of information in the list on the screen displayed by the first display unit is hidden.

7. The display device according to claim 4, wherein a size of a character included in the list on the screen displayed by the first display unit is equal to a size of a character included in the list on the screen displayed by the second display unit.

8. The display device according to claim 1, wherein the screen is a setting screen for making various settings of an image forming apparatus.

9. A method of controlling a display device including a display, a first display unit for displaying a screen including a scrollable list containing a plurality of information represented by characters on the display, and a second display unit for displaying the screen on the display in a format different from the first display unit, the method comprising:
accepting flick operation to scroll the list in a predetermined direction; and
deciding a scroll speed to scroll-display the list, based on which of the first and second display units displays the screen when flick operation is accepted, wherein
a scroll speed for the accepted predetermined flick operation is decided such that a scroll speed of the list displayed by the first display unit is slower than a scroll speed of the list displayed by the second display unit, in one of the following cases:
(i) a size of a character in a case where the entire screen is displayed by the first display unit is smaller than a size of a character in a case where the entire screen is displayed by the second display unit;
(ii) a length in a scroll direction of a display area for the list in a case where the entire screen is displayed by the second display unit is longer than a length in the scroll direction of a display area for the list in a case where the entire screen is displayed by the first display unit;
(iii) a screen displayed by the first display unit includes a thumbnail related to the list, and a screen displayed by the second display unit does not include a thumbnail related to the list; and
(iv) the list on the screen displayed by the second display unit is a list in which part of information in the list on the screen displayed by the first display unit is hidden.

10. A non-transitory computer-readable recording medium encoded with a control program for a display device including a display, a first display unit for displaying a screen including a scrollable list containing a plurality of information represented by characters on the display, and a second display unit for displaying the screen on the display in a format different from the first display unit, the program causing a computer to execute:
accepting flick operation to scroll the list in a predetermined direction; and
deciding a scroll speed to scroll-display the list, based on which of the first and second display units displays the screen when flick operation is accepted, wherein
a scroll speed for the accepted predetermined flick operation is decided such that a scroll speed of the list displayed by the first display unit is slower than a scroll speed of the list displayed by the second display unit, in one of the following cases:
(i) a size of a character in a case where the entire screen is displayed by the first display unit is smaller than a size of a character in a case where the entire screen is displayed by the second display unit;
(ii) a length in a scroll direction of a display area for the list in a case where the entire screen is displayed by the second display unit is longer than a length in the scroll direction of a display area for the list in a case where the entire screen is displayed by the first display unit;
(iii) a screen displayed by the first display unit includes a thumbnail related to the list, and a screen displayed by the second display unit does not include a thumbnail related to the list; and
(iv) the list on the screen displayed by the second display unit is a list in which part of information in the list on the screen displayed by the first display unit is hidden.
